(19) United States
(12) Patent Application Publication
(10) Pub. No.: US 2008/0272655 A1
(43) Pub. Date: Nov. 6, 2008

(54) Uninterruptible Power Supply With Remote Capabilities

(76) Inventors: Brooks Vaughan, Houston, TX (US); Brandon W. Fears, Houston, TX (US); Keith J. Kuehn, Spring, TX (US); Darrel G. Gaston, Spring, TX (US); Douglas R. Woellner, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/743,632

(22) Filed: May 2, 2007

(51) Int. Cl. H02J 9/00

(52) U.S. Cl. 307/66

(57) ABSTRACT

An Uninterruptible Power Supply (UPS) with remote capabilities, and systems and methods of implementing the same, are disclosed. An exemplary UPS system with remote capabilities includes a battery unit and a remote unit configured to be physically separated from the battery unit so that a user can electrically connect an electronic device to the battery unit without having to physically connecting the electronic device directly to the battery unit. The UPS system also includes a user interface on the remote unit. The user interface is operable to output status of the battery to a user even if the user is separated from the battery unit.

### BACKGROUND

Uninterruptible Power Supply (UPS) devices are commonly available for computer systems and other electronic devices where uninterrupted power is desired (e.g., during a power outage). The UPS device replaces or supplements electrical power from the utility company with electrical power from a battery (or batteries) in the UPS device. The battery is able to provide power at least for a limited time, until electrical power form the utility company can be restored. Once electrical power is restored, the electrical power is used to recharge the battery in the UPS device so that the battery is fully charged the next time there is a power outage.

UPS devices are often located in hard to reach places. For example, a UPS for a personal computer (PC) may be located behind the desk where the PC is being used so that it is out of sight and close to the electrical outlet. Accordingly, the user is inconvenienced each time the user has to plug or unplug a power cord to the UPS device. Although the user may use an extension cord between the UPS device and a more convenient location for plugging/unplugging devices, the user is still inconvenienced each time the user has to check the status indicators on the UPS device (e.g., to determine if the battery is properly charged/charging). In addition, using extension cords may degrade the quality of the electrical power being supplied by the UPS device to the computer system or other electronic device. The use of extension cords may also introduce electrical noise to the electrical power being supplied by the UPS device, degrading operation of the computer system or other electronic devices.

### BRIEF DESCRIPTION OF THE DRAWINGS

FIG. 1 is a perspective view of an exemplary Uninterruptible Power Supply (UPS) device with remote capabilities. FIGS. 1a-c are plan views of the exemplary UPS device with remote capabilities shown in FIG. 1, wherein (a) is a top plan view, (b) is a front plan view, and (c) is a side plan view.

FIG. 2 is a high-level circuit diagram showing exemplary circuitry which may be implemented by the UPS device for providing remote capabilities.

FIG. 3 is a flowchart illustrating exemplary operations which may be implemented by the UPS device for providing remote capabilities.

### DETAILED DESCRIPTION

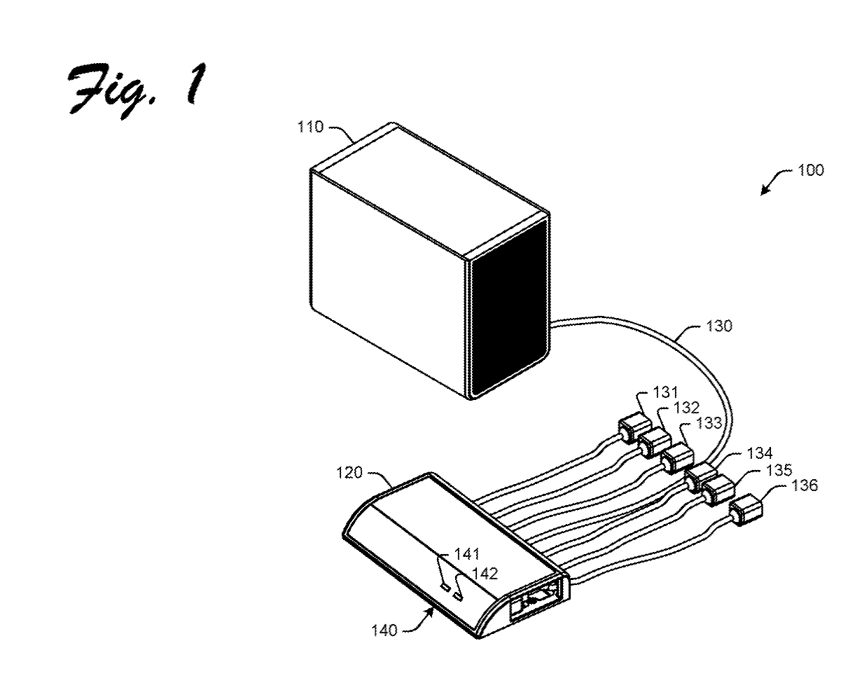

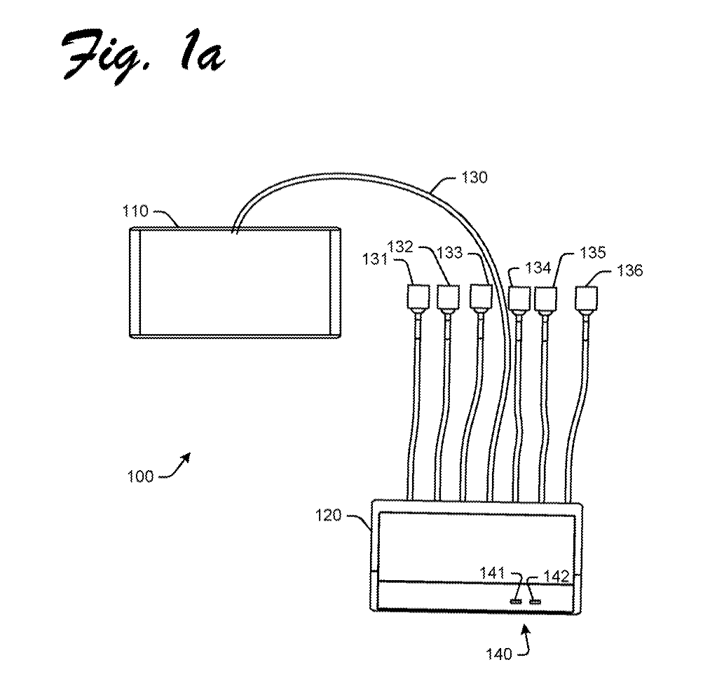

FIG. 1 is a perspective view of an exemplary Uninterruptible Power Supply (UPS) device 100 with remote capabilities. Reference is also made to FIGS. 1a-c. FIGS. 1a-c are plan views of the exemplary UPS device 100 with remote capabilities shown in FIG. 1, wherein (a) is a top plan view, (b) is a front plan view, and (c) is a side plan view.

The UPS device 100 may include a primary unit 110 housing a auxiliary power source, such as a battery or batteries (not shown). The primary unit 110 may also be connected by a power cord (not shown) to a primary electrical power source, such as a wall outlet providing AC electrical power from the utility company.

The UPS device 100 also includes a remote unit 120 electrically connected to the primary unit 110 by power cord 130. The remote unit 120 may include one or more connections for electrically connecting any of a wide variety of electronic devices to power being supplied by the UPS device 100. In use, the primary unit 110 may be located near a power source (e.g., a wall outlet) behind furniture such as a desk or file cabinet so that it is out-of-sight, while the remote unit 120 may be more conveniently located for the user. Accordingly, the user can easily access the remote unit to make connections to the UPS device 100 and check the status of operations. The smaller size of the remote unit 120 relative to the primary unit 110 also enables positioning of the remote unit 120 in a variety of different orientations, in drawers, under computer monitors, etc.

In the example shown in FIGS. 1 and 1a-c, connections 131-136 are shown on cords connected to the remote unit 120. The cords enable the connections to be readily routed (e.g., behind the user's desk), while maintaining the ability to easily reach the connections 131-136. It is noted, however, that any suitable connections may be provided on the remote unit 120 and/or on the primary unit 110 of UPS device 100.

The remote unit 120 may also include a user interface 140 for displaying output for a user and/or receiving input from a user. This input/output may be relayed between the primary unit 110 and the remote unit 120 by signal wiring (e.g., in cord 130) or wireless communications. For purposes of illustration, user interface 140 may include light-emitting diode (LED) status indicators 141 and 142. The status indicators 141 and 142 may be lit to indicate whether power is being supplied by the primary power source or by the auxiliary source (or a combination thereof), or to indicate performance, problems, etc.

Of course user interface 140 is not limited to LED status indicators 141 and 142 and may include any of a wide variety of input/output (I/O). User interface may also be used for any of a wide variety of input and/or output at the remote unit. Other examples, include, but are not limited to, a reset function, a test feature, power on/off, etc.

During use the UPS device 100 provides electrical power from the primary power source to one or more electronic devices connected to the UPS device 100, e.g., by operating in a “pass-through” mode. If the primary power source is disrupted (e.g., during a power failure), or degraded, the UPS device 100 may instead provide electrical power to the one or more electronic devices connected to the UPS device 100 from the auxiliary power source (e.g., the battery).

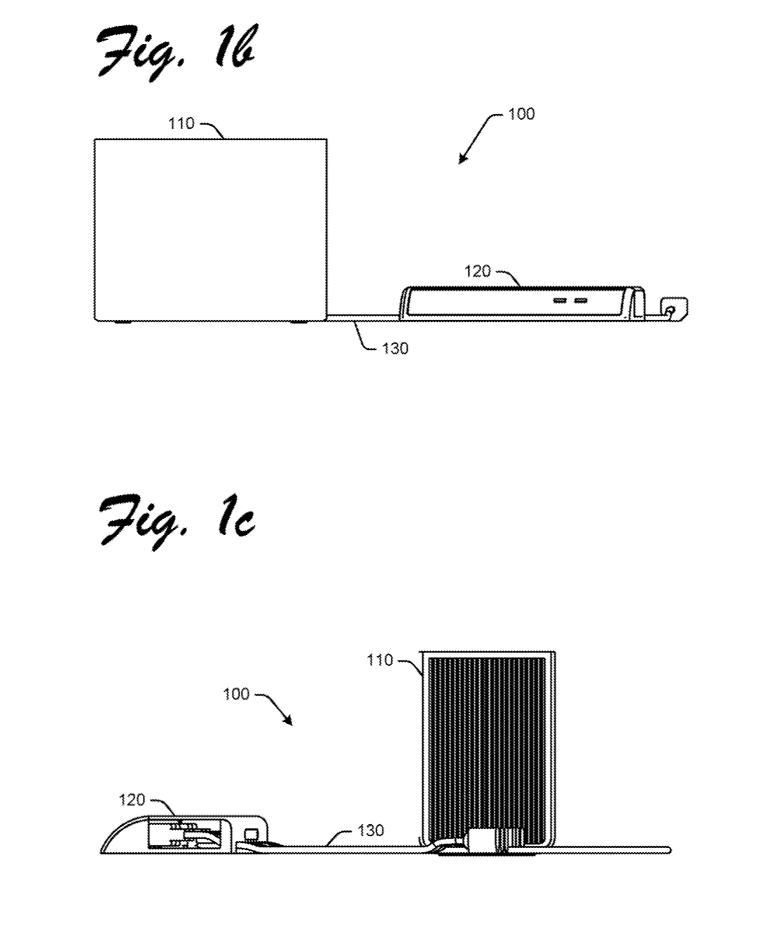

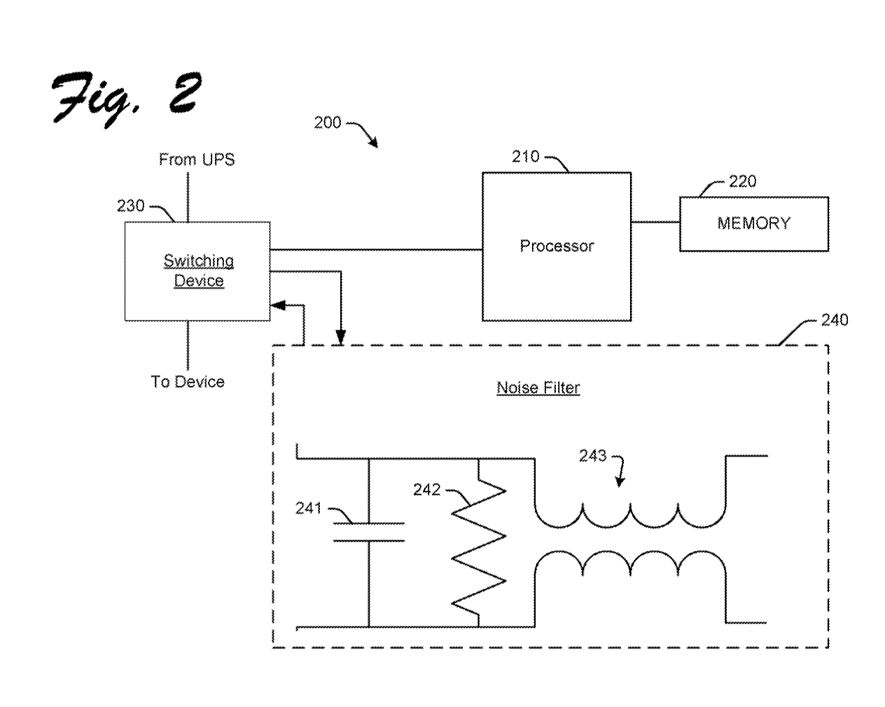

Depending on the length of the cord 130 and/or other operating conditions, power being supplied by the UPS device 100 may generate noise that affects the operation of the electronic devices connected to the UPS device 100. Optionally, the UPS device may include other remote capabilities, such as noise filtering. An exemplary circuit for filtering noise is discussed in more detail below with reference to FIG. 2.

Before continuing, it is noted that the UPS device 100 may be used with any of a wide variety of computing systems or other electronic devices, such as a stand-alone personal desktop or laptop computer (PC), workstation, personal digital assistant (PDA), consumer electronic (CE) devices, or appliance, to name only a few examples.

FIG. 2 is a high-level circuit diagram 200 showing exemplary circuitry which may be implemented by the UPS device 100 for providing remote capabilities. In an exemplary embodiment, the circuitry is provided at the remote unit 120, although one or more component of the circuitry may also be provided at the primary unit 110.

The circuitry may include a processor 210 (or processing units) operatively associated with computer readable storage 220 or memory. During operation, computer readable program code (e.g., firmware and/or software) may be stored in memory 220 and executed by the processor 210 to implement one or more of the remote capabilities.

In an exemplary embodiment, the processor 210 may control a switching device 230. The switching device 230 is provided in-line with power being provided from the UPS device 100 (e.g., from the primary and/or auxiliary power source) to the one or more electronic devices connected to the UPS device 100.

The program code may include an optional sensing module. In an exemplary embodiment, the sensing module monitors the quality of the power signal being provided by the UPS device 100. If the quality of the power signal satisfies a noise threshold, the switching device 230 operates in a pass-through mode, allowing electrical power from the power source to be provided directly to the electronic devices connected to the UPS device 100. If the quality of the power signal fails to satisfy the noise threshold, power is filtered, e.g., by passing at least part of the power signal through a noise filter 240.

Although noise filters may take any suitable form, and will depend at least in part on various design considerations, exemplary noise filter 240 may include a capacitor 241 (or capacitors) in parallel with a resistor 242 (or resistors) in parallel with an inductor 243. The sizing of the various components, again, depends on various design considerations.

It is noted that the noise threshold may be determined based on any of a wide variety of design considerations, such as operating parameters, type of equipment being operated, number of electronic devices connected to the UPS device, desired noise reduction, etc. The noise threshold may be either constant or variable, again depending on these or other design considerations. It is also noted that the remote capabilities may be implemented using any of a wide variety of different circuitry. In an alternative embodiment, for example, the functions of the program code may be implemented by logic circuitry.

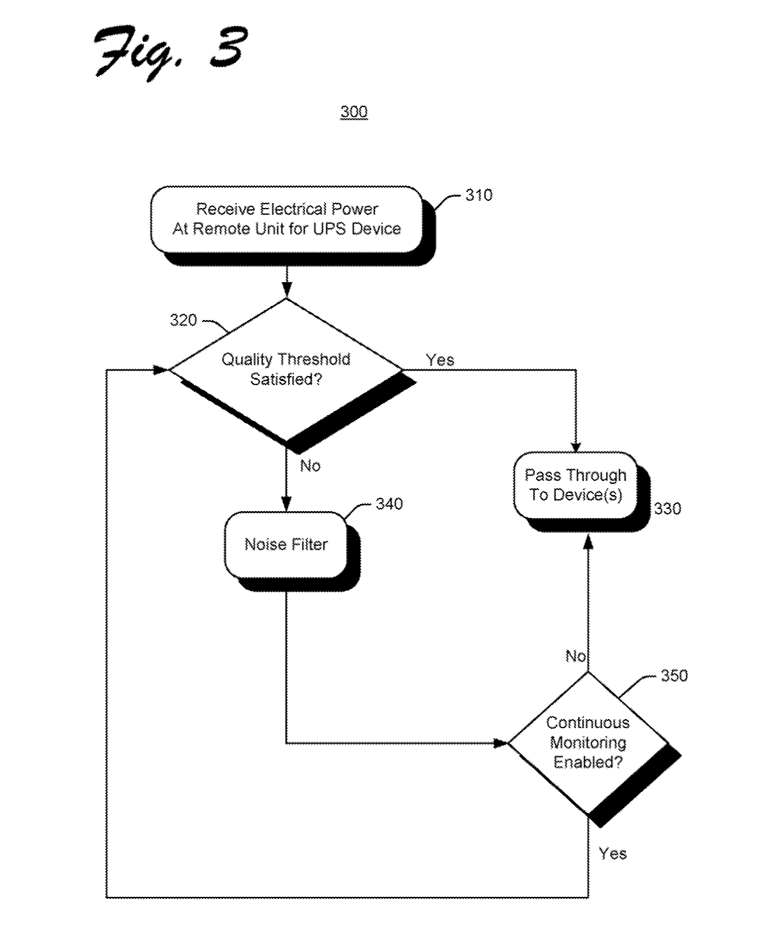

FIG. 3 is a flowchart illustrating exemplary operations 300 which may be implemented by the UPS device for providing remote capabilities. Operations 300 may be embodied as logic instructions on one or more computer-readable medium in the remote unit of the UPS device. When executed on a processor in the remote unit of the UPS device, the logic instructions cause a general purpose computing device to be programmed as a special-purpose machine that implements the described operations. Alternatively, the operations may be implemented in hardware (e.g., device logic). In an exemplary implementation, the components and connections depicted in the figures may be used for the described operations.

In operation 310, a power signal is received at the remote unit for the UPS device. In operation 320, a determination is made whether a quality threshold is satisfied. If the quality threshold is satisfied, the electrical power may be passed through to the device(s) connected to the UPS device in operation 330. If the quality threshold is not satisfied, the electrical power may be passed through a noise filter in the remote unit of the UPS device in operation 340.

If continuous monitoring is not enabled in operation 350, the electrical power continues to be passed through to the device in operation 330 via the noise filter. If continuous monitoring is enabled in operation 350, the electrical power continues to be checked against the quality threshold by returning to operation 320. For example, if the noise is migrant, the electrical signal does not need to be continuously filtered for noise. However, if the noise is recurring, continuous filtering for noise may be desired.

The operations shown and described herein are provided to illustrate exemplary implementations for providing remote capabilities in a UPS. It is noted that the operations are not limited to the ordering shown. For examples, operations may be ordered one before the other or performed simultaneously with one another. Still other operations not shown may also be implemented. For example, operations may further include notifying the user if the quality threshold is not met in operation 320 (e.g., via the display at the remote unit).

The exemplary embodiments shown and described are provided for purposes of illustration and are not intended to be limiting. Still other embodiments are also contemplated for providing remote capabilities in a UPS.

1. A UPS system with remote capabilities for separately connecting to an electronic device such as a computer system, the UPS system comprising:
a battery unit;
a remote unit configured to be physically separated from a housing for the battery unit so that a user can electrically connect the electronic device to the battery unit without having to physically connect the electronic device directly to the housing of the battery unit; and
a user interface on the remote unit, the user interface operable to output status of the battery to a user even if the user is separated from the battery unit.

2. The UPS system of claim 1 wherein the user interface on the remote unit is operable to receive input from the user in response to the output status.

3. The UPS system of claim 1 further comprising logic for determining if electrical power supplied by the battery unit satisfies a quality threshold at the remote unit.

4. The UPS system of claim 3 wherein the logic includes a processor and program code.

5. The UPS system of claim 3 wherein the logic includes device circuitry.

6. The UPS system of claim 3 wherein determining if electrical power supplied by the battery unit satisfies the quality threshold is continuous.

7. The UPS system of claim 3 wherein the logic for determining if electrical power supplied by the battery unit satisfies the quality threshold can be enabled/disabled.

8. The UPS system of claim 1 further comprising a noise filter for reducing noise in the electrical power at the remote unit.

9. The UPS system of claim 8 wherein the noise filter is switched on only if a quality threshold for the electrical power is not satisfied.

10. A method comprising:
receiving electrical power at a remote unit electrically connected to a battery in a UPS device;
monitoring quality of the electrical power received at the remote unit; and
enhancing the quality of the electrical power at the remote unit before delivering the electrical power to a connected device.

11. The method of claim 10 wherein enhancing the quality of the electrical power occurs only if a quality threshold is not met.

12. The method of claim 10 wherein enhancing the quality of the electrical power includes filtering noise in the electrical power.

13. The method of claim 10 wherein monitoring and enhancing occur only if the electrical power is received from the battery in the UPS device.

14. The method of claim 10 wherein monitoring is continuous.

15. The method of claim 10 wherein continuous monitoring can be enabled/disabled.

16. A UPS system with remote capabilities comprising:
backup means for providing backup electrical power;
remote means for electrically connecting a device to the backup electrical power without physically connecting the device to the backup means; and
status means for outputting a status of the backup electrical power even if the status means is separated from the backup means.

17. The UPS system of claim 16 further comprising means for monitoring quality of the electrical power at the remote means.

18. The UPS system of claim 17 wherein the means for monitoring quality includes means for checking a quality threshold at the remote means.

19. The UPS system of claim 16 further comprising means for enhancing quality of the electrical power at the remote means before delivering the electrical power to the device.

20. The UPS system of claim 19 wherein the means for enhancing quality of the electrical power at the remote means includes means for filtering noise.
